(19) United States
(12) Patent Application Publication
(10) Pub. No.: US 2024/0010364 A1
(43) Pub. Date: Jan. 11, 2024

(54) CONTROL DEVICE, MOVING BODY, CONTROL METHOD, AND CONTROL PROGRAM

(71) Applicant: TOYOTA JIDOSHA KABUSHIKI KAISHA, Toyota-shi (JP)

(72) Inventors: Hiroaki HANZAWA, Toyota-shi (JP); Ruibai LI, Toyota-shi (JP); Shingo HASEGAWA, Toyohashi-shi (JP); Kotaro NAKAYAMA, Toyota-shi (JP)

(21) Appl. No.: 18/346,983

(22) Filed: Jul. 5, 2023

(30) Foreign Application Priority Data
Jul. 5, 2022 (JP) 2022-108563

(51) Int. Cl. B64G 1/42; B64G 1/16

(52) U.S. Cl. CPC B64G 1/428; B64G 1/16

(57) ABSTRACT

A control device includes a memory; and a processor coupled to the memory. The processor is configured to acquire a status of each of a plurality of power distribution pathways provided at a moving body, and select a power distribution pathway having low resistance from among the plurality of power distribution pathways based on the acquired status, and cause power to be distributed via the selected power distribution pathway.

### CROSS-REFERENCE TO RELATED APPLICATION

This application is based on and claims priority under 35 USC 119 from Japanese Patent Application No. 2022-108563 filed on Jul. 5, 2022, the disclosure of which is incorporated by reference herein.

### BACKGROUND

### Technical Field

The present disclosure relates to a control device, a moving body, a control method, and a control program.

### Related Art

Technology relating to a vehicle employed in exploration activities on the moon, mars, or another planet is disclosed. Technology relating to mobile vehicles employed in space exploration is disclosed in International Publication (WO) No. 2018/29840.

A vehicle employed for planetary exploration activities is driven by electric power accumulated in a battery. Particularly in a space environment, a significant temperature rise occurs on a side of the vehicle where the sun is visible due to there being either no atmosphere present or only a thin atmosphere. Generally resistance rises at high temperatures in materials employed for power distribution in a vehicle. Namely, a temperature rise leads to a rise in loss, such as due to wiring resistance and the like, in a power distribution pathway provided in a vehicle. Charging a battery is not easy in a space environment, there is an increase in loss power when loss rises, with this leading to a drop in the available cruising range of the vehicle due to the increase in loss power.

### SUMMARY

An aspect of the disclosure is a control device including a memory, and a processor coupled to the memory, wherein the processor is configured to acquire a status of each of a plurality of power distribution pathways provided at a moving body, and select a power distribution pathway having low resistance from among the plurality of power distribution pathways based on the acquired status, and cause power to be distributed via the selected power distribution pathway.

### BRIEF DESCRIPTION OF THE DRAWINGS

Exemplary embodiments of the present disclosure will be described in detail based on the following figures, wherein:

FIG. 1 is a diagram illustrating a schematic configuration of a moving body according to an exemplary embodiment;

FIG. 2 is a block diagram illustrating a hardware configuration of an ECU;

FIG. 3 is a block diagram illustrating an example of a functional configuration of an ECU;

FIG. 4 is a flowchart illustrating a flow of control processing by an ECU;

FIG. 5 is a diagram illustrating a schematic configuration of a moving body according to the present exemplary embodiment; and

FIG. 6 is a flowchart illustrating a flow of control processing by an ECU.

### DETAILED DESCRIPTION

Description follows regarding an example of an exemplary embodiment of the present disclosure, with reference to the drawings. Note that the same reference numerals are appended to the same or equivalent configuration elements and parts in each drawing. The dimensional proportions in the drawings are exaggerated for ease of explanation, and sometimes differ from actual proportions.

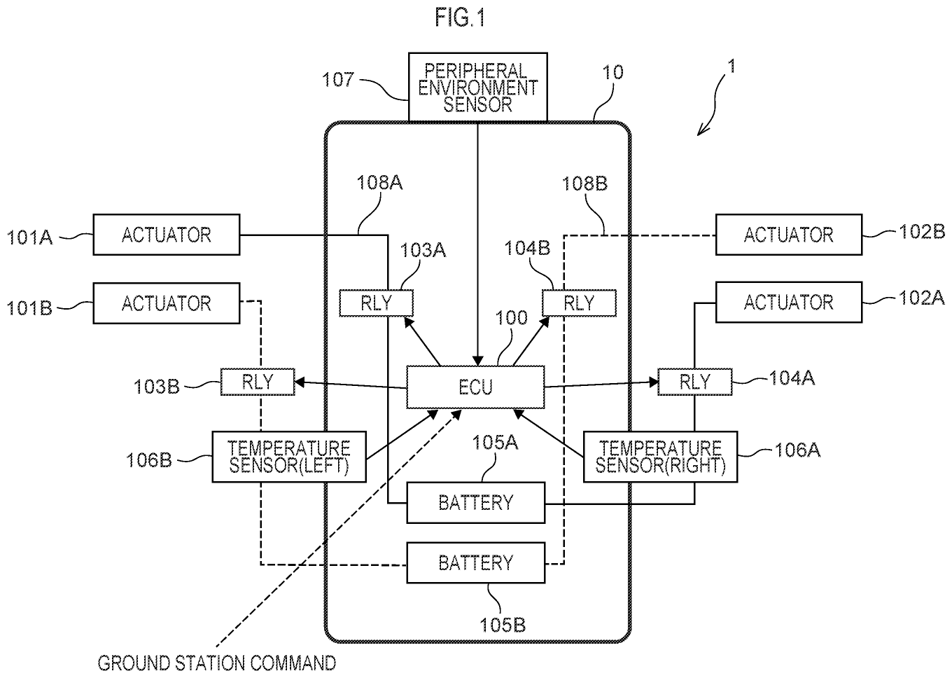

FIG. 1 is a diagram illustrating a schematic configuration of a moving body according to the present exemplary embodiment.

A moving body 1 illustrated in FIG. 1 is a moving body for exploring, for example, the moon or a planet such as mars. The moving body 1 is a vehicle configured so as to travel or stop based on commands received from a ground station on earth using satellite communication or the like.

As illustrated in FIG. 1, the moving body 1 includes an electronic control unit (ECU) 100, actuators 101A, 101B, 102A, 102B, relays 103A, 103B, 104A, 104B, batteries 105A, 105B, temperature sensors 106A, 106B, and a peripheral environment sensor 107. The moving body 1 illustrated in FIG. 1 has a forward direction that is upward in the drawing.

The ECU 100 is an example of a control device of the present disclosure, and controls each configuration provided to the moving body 1 and performs various computational processing. In the present exemplary embodiment, the ECU 100 checks a status in the surroundings of the moving body 1 based on information acquired from the temperature sensors 106A, 106B, the peripheral environment sensor 107, and/or the ground station. Based on the status in the surroundings of the moving body 1, the ECU 100 selects a power distribution pathway of low resistance from out of two power distribution pathways, these being an A system 108A and a B system 108B, provided in the moving body 1.

In the present exemplary embodiment, the system 108A is wiring outside a vehicle body 10 when on a left side of the moving body 1 and wiring inside the vehicle body 10 when on the right side of the moving body 1. The B system 108B is wiring inside the vehicle body 10 when on the left side of the moving body 1, and is wiring outside the vehicle body 10 when on the right side of the moving body 1.

More specifically, the ECU 100 ascertains the side of the moving body 1 that has reached a high temperature. The ECU 100 performs control so as not to select the power distribution pathway on the side at high temperature and so as to instead select the power distribution pathway on the side that is at low temperature. In other words, the ECU 100 selects the power distribution pathway of low resistance based on the information related to the temperature of the power distribution pathways.

The following expression holds for the power required P_{High} when the ECU 100 has selected the high temperature power distribution pathway:

P_{High}=IV=I²R_{High}

wherein P_{High} is the power required, R_{High} is the resistance of the high temperature power distribution pathway, I is the current flowing in the high temperature power distribution pathway, and V is the voltage applied to the high temperature power distribution pathway.

Moreover, the following expression holds for the power required P_{Low} when the ECU 100 has selected the low temperature power distribution pathway:

P_{Low}=IV=I²R_{Low}

wherein P_{Low} is the power required, R_{Low} is the resistance of the low temperature power distribution pathway, I is the current flowing in the low temperature power distribution pathway, and V is the voltage applied to the low temperature power distribution pathway.

Resistance rises at high temperatures in materials generally employed for power distribution pathways resulting in R_{High}>R_{Low}, and so when comparing P_{High} against P_{Low}, P_{High}>P_{Low}. Thus the ECU 100 selecting the low temperature power distribution pathway enables a reduction in power consumption of an amount ΔP, as set out below.

ΔP=P_{High}−P_{Low}

The ECU 100 selects the power distribution pathway of low resistance based on the status in the surroundings of the moving body 1, and is accordingly able to suppress an increase in loss power of the moving body 1 and suppress the available cruising range of the moving body 1 from dropping in comparison to cases in which such selection is not made.

The actuators 101A, 101B, 102A, 102B are devices employed to drive the moving body 1. In the present exemplary embodiment, the actuators 101A, 101B are employed to drive non-illustrated left wheels, and the actuators 102A, 102B are employed to drive non-illustrated right wheels.

The relays 103A, 103B, 104A, 104B are devices that perform power supply or interruption of power supply under instruction from the ECU 100. In the example illustrated in FIG. 1, the relays 103A, 104B are provided inside the vehicle body 10, and the relays 103B, 104A are provided outside the vehicle body 10.

The batteries 105A, 105B are batteries in which power for driving the moving body 1 is accumulated. In the example illustrated in FIG. 1, power for driving the actuators 101A, 102A is accumulated in the battery 105A through the A system 108A, and power for driving the actuators 101B, 102B is accumulated in the battery 105B through the B system 108B.

Note that although in the present exemplary embodiment an example is illustrated in which the two batteries 105A, 105B are provided to the moving body 1 in consideration of malfunction down time, the present disclosure is not limited to such an example for the number of batteries.

The temperature sensors 106A, 106B are sensors that measure the temperature of the surroundings of the moving body 1. The temperature sensor 106A is a sensor that measures the temperature on the travel direction right side of the moving body 1. The temperature sensor 106B is a sensor that measures the temperature on the travel direction left side of the moving body 1. The results of measuring the temperature with the temperature sensors 106A, 106B are sent to the ECU 100. The A system 108A and the B system 108B are each able to acquire a status regarding the respective temperature using the temperature sensors 106A, 106B.

The peripheral environment sensor 107 is a sensor that acquires information about the environment at the periphery of the moving body 1. A camera that captures the surroundings of the moving body 1 may, for example, be employed as the peripheral environment sensor 107. Images captured by the camera of the surroundings of the moving body 1 are sent to the ECU 100, and the ECU 100 is accordingly able to find the relative position of the sun with respect to the moving body 1. The ECU 100 is able to surmise the high temperature side of the moving body 1 by knowing the relative position of the sun with respect to the moving body 1. Namely, the ECU 100 is able to indirectly acquire a status regarding temperature in the surroundings of the moving body 1 from the information acquired by the peripheral environment sensor 107.

Description now follows regarding a hardware configuration of the ECU 100.

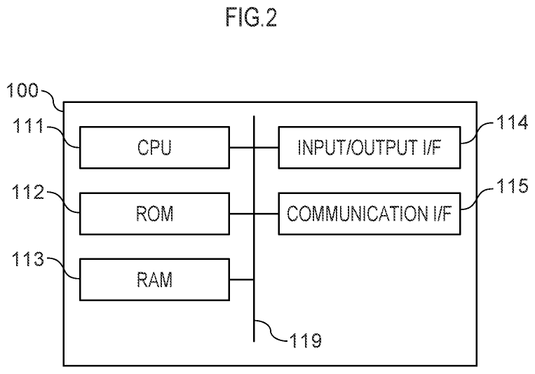

FIG. 2 is a block diagram illustrating a hardware configuration of the ECU 100.

As illustrated in FIG. 2, the ECU 100 includes a central processing unit (CPU) 111, read only memory (ROM) 112, random access memory (RAM) 113, an input/output interface (I/F) 114, and a communication interface (I/F) 115. Each configuration is connected together through a bus 119 so as to be able to communicate with each other.

The CPU 111 serving as an example of a hardware processor, is a central processing unit that executes various programs and controls each section. Namely, the CPU 111 reads a program from the ROM 112 serving as an example of a non-transitory recording medium, and executes the program using the RAM 113 serving as an example of memory as workspace. The CPU 111 controls each configuration and performs various computational processing according to the program recorded on the ROM 112. In the present exemplary embodiment, a control program to perform control related to use of power distribution pathways provided to the moving body 1 is stored in the ROM 112.

The ROM 112 is stored with various programs including an operating system and with various data. The RAM 113 is employed as workspace for temporarily storing programs and/or data. Storage configured by a storage device such a hard disk drive (HDD), solid state drive (SSD), or flash memory may also be provided to the ECU 100.

The input/output interface 114 is an interface for inputting and outputting information to and from devices such as the relays 103A, 103B, 104A, 104B, the temperature sensors 106A, 106B, and the peripheral environment sensor 107 provided to the moving body 1.

The communication interface 115 is an interface for communicating with other devices, such as the ground station.

When executing the control program described above, the ECU 100 implements each function thereof using the above hardware resources. Description follows regarding the functional configuration implemented by the ECU 100.

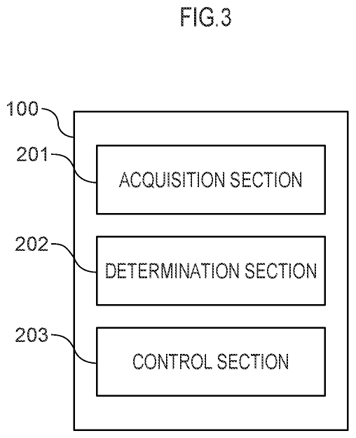

FIG. 3 is a block diagram illustrating an example of a functional configuration of the ECU 100.

As illustrated in FIG. 3, the ECU 100 includes, as functional configuration, an acquisition section 201, a determination section 202, and a control section 203. Each of the functional configuration is implemented by the CPU 111 reading and executing the control program stored on the ROM 112.

The acquisition section 201 acquires the respective statuses of the plural power distribution pathways provided to the moving body 1 (the two power distribution pathways of the A system 108A and the B system 108B in FIG. 1). More specifically, the acquisition section 201 either directly or indirectly acquires the status related to the respective temperature of the plural power distribution pathways provided to the moving body 1.

For example, the acquisition section 201 may directly acquire the status related to the respective temperature of the power distribution pathways by acquiring respective temperatures measurement values of the A system 108A and the B system 108B as measured by the temperature sensors 106A, 106B. Moreover, for example, by acquiring the status of the surroundings of the moving body 1 as acquired by the peripheral environment sensor 107, the acquisition section 201 may indirectly acquire the temperature status of the surroundings of the moving body 1 from the information acquired by the peripheral environment sensor 107.

The determination section 202 determines which side of the moving body 1 is at high temperature using the respective statuses of the plural power distribution pathways provided to the moving body 1 as acquired by the acquisition section 201. In cases in which temperatures have been directly acquired using the temperature sensors 106A, 106B, the determination section 202 determines which side of the moving body 1 is at high temperature based on the temperature measurement values.

Based on the determination result of the determination section 202, the control section 203 then selects the power distribution pathway of low resistance from out of the plural power distribution pathways provided to the moving body 1, and controls so that power is distributed by the selected power distribution pathway. More specifically, based on the determination result of the high temperature side by the determination section 202, the control section 203 selects the power distribution pathway on the low temperature side from out of the plural power distribution pathways provided to the moving body 1, and controls such that power is distributed by the selected power distribution pathway.

More specifically, in cases in which the determination section 202 has determined that the left side of the moving body 1 is the low temperature side, the control section 203 controls so as to switch the relays 103B, 104B ON, and to switch the relays 103A, 104A OFF. Thus the control section 203 controls so as to select the B system 108B in cases in which the determination section 202 has determined the left side of the moving body 1 to be the low temperature side.

However, in cases in which the determination section 202 has determined the right side of the moving body 1 to be the low temperature side, the control section 203 controls so as to switch the relays 103A, 104A ON, and to switch the relays 103B, 104B OFF. Thus the control section 203 controls so as to select the A system 108A in cases in which the determination section 202 has determined the right side of the moving body 1 to be the low temperature side.

The timings of the determination processing by the determination section 202 and the control processing by the control section 203 are not particularly limited. For example, the determination processing by the determination section 202, and the control processing by the control section 203, may be performed when the moving body 1 is started up, and may be performed periodically at a predetermined interval. Moreover, the determination processing by the determination section 202, and the control processing by the control section 203, may be performed at a timing when the moving body 1 is stopped.

The ECU 100 has such a configuration, and so is able to select the power distribution pathway of low wiring resistance according to status. By selecting the power distribution pathway of low wiring resistance, the ECU 100 is able to suppress an increase in loss power of the moving body 1 in comparison to cases in which the power distribution pathway of low wiring resistance is not selected.

Next, description follows regarding operation of the ECU 100.

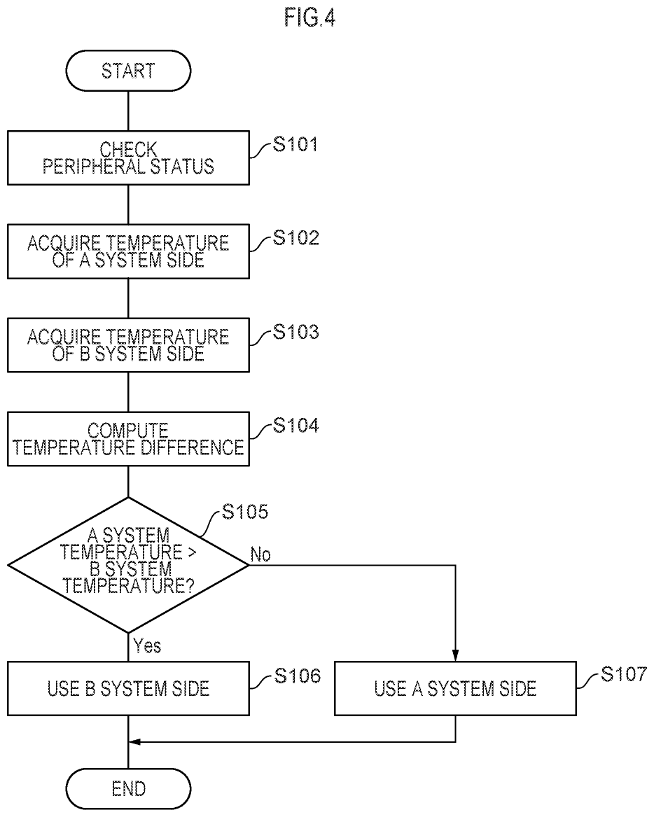

FIG. 4 is a flowchart illustrating a flow of control processing by the ECU 100. The control processing is performed by the CPU 111 reading the control processing from the ROM 112, and expanding the control program in the RAM 113, and executing the control processing.

The CPU 111 first, at step S101, checks a peripheral status of the moving body 1. The CPU 111 checks the peripheral status of the moving body 1 based on, for example, information acquired from the temperature sensors 106A, 106B, the peripheral environment sensor 107, and/or the ground station.

Next following on from step S101, at step S102 the CPU 111 acquires the temperature of the A system 108A side. The CPU 111 may acquire the temperature of the A system 108A side directly from the temperature sensor 106A, or may acquire the temperature indirectly from the peripheral environment sensor 107.

Next following on from step S102, at step S103 the CPU 111 acquires the temperature of the B system 108B side. The CPU 111 may acquire the temperature of the B system 108B directly from the temperature sensor 106B or may acquire the temperature indirectly from the peripheral environment sensor 107. Note that although in the flowchart illustrated in FIG. 4, the CPU 111 acquires temperatures in the sequence of the A system 108A then the B system 108B, the CPU 111 may acquire temperatures in the sequence of the B system 108B and then the A system 108A.

Next following on from step S103, at step S104 the CPU 111 computes a temperature difference between the temperature on the A system 108A side and the temperature on the B system 108B side. The CPU 111 may compute the temperature difference as is, or may compute which of the systems is at the higher temperature.

Next following on from step S104, at step S105 the CPU 111 determines which is higher out of the temperature on the A system 108A side and the temperature on the B system 108B side.

When the result of determination of step S105 is that the temperature of the A system 108A side is greater than the temperature of the B system 108B side (step S105: Yes), then at step S106 the CPU 111 decides to use the B system 108B side for power distribution.

Namely, the CPU 111 switches the relays 103B, 104B ON, and switches the relays 103A, 104A OFF.

However, when the result of determination of step S105 is that the temperature of the A system 108A side is not greater than the temperature of the B system 108B side (step S105: No), then at step S107 the CPU 111 decides to use the A system 108A side for power distribution. Namely, the CPU 111 switches the relays 103A, 104A ON, and switches the relays 103B, 104B OFF.

By executing the above cycle of processing the ECU 100 is able to select the power distribution pathway of low wiring resistance according to status. By selecting the power distribution pathway of low wiring resistance, the ECU 100 is able to suppress an increase in the loss power of the moving body 1 in comparison to cases in which the power distribution pathway of low wiring resistance is not selected.

Although the example described above illustrates an example in which the ECU 100 selects the power distribution pathway of low wiring resistance based on information related to temperature, the present disclosure is not limited so such an example. The ECU 100 may surmise a resistance value of power distribution pathways, and then select the power distribution pathway of low wiring resistance based on the surmised result.

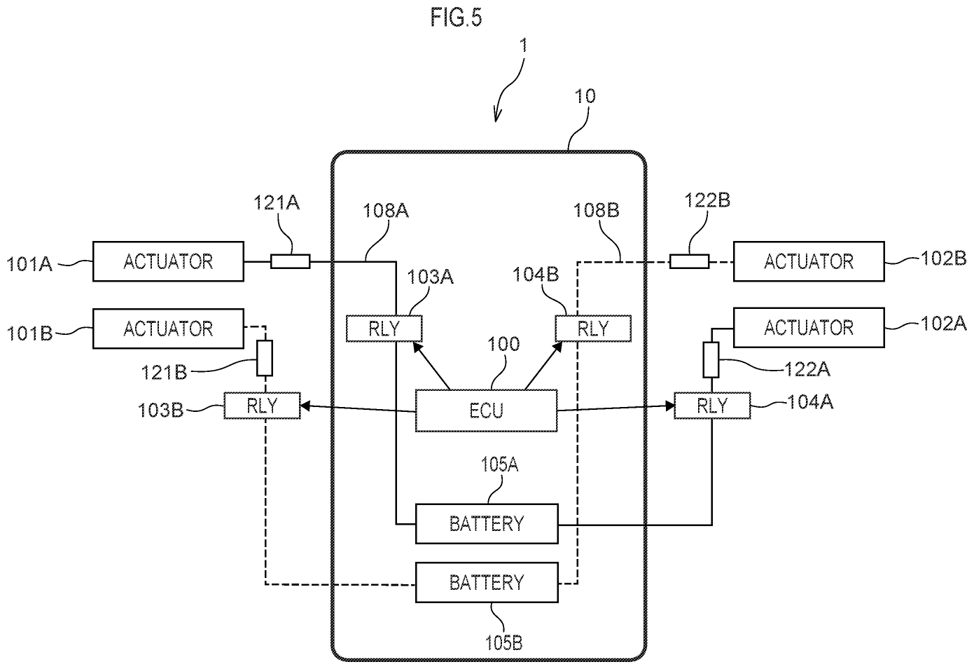

FIG. 5 is a diagram illustrating a schematic configuration of a moving body according to the present exemplary embodiment.

The moving body 1 illustrated in FIG. 5 differs from the moving body 1 illustrated in FIG. 1 in that there are input voltage meters 121A, 121B, 122A, 122B provided thereto. The input voltage meters 121A, 121B, 122A, 122B are voltage meters that measure the voltages respectively input to the actuators 101A, 101B, 102A, 102B.

The ECU 100 computes the respective resistances of the A system 108A and the B system 108B from a voltage drop obtained from the input voltages measured at the input voltage meters 121A, 121B, 122A, 122B in cases in which a given load (for example 10 W) is being consumed in both the A system 108A and the B system 108B. The ECU 100 then selects the A system 108A or the B system 108B based on the computation result of resistances and controls such that the selected system is used for power distribution.

Next, explanation follows regarding operation of the ECU 100.

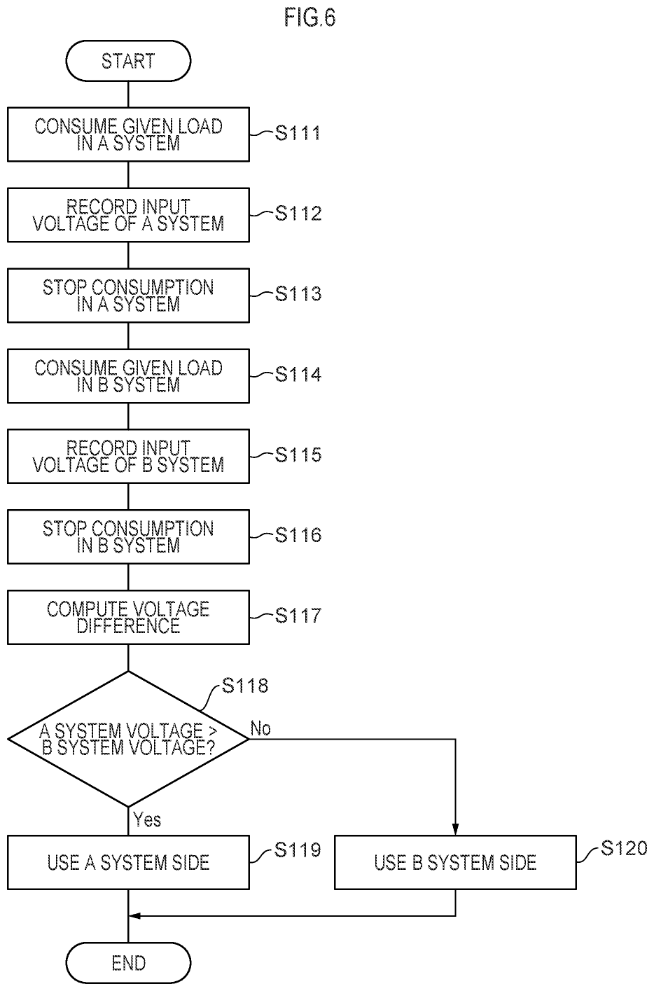

FIG. 6 is a flowchart illustrating a flow of control processing by the ECU 100. The CPU 111 reads a control program from the ROM 112, and performs control processing by expanding the control program in the RAM 113 and executing the control program.

The CPU 111 first at step S111 switches the relays 103A, 104A ON and switches the relays 103B, 104B OFF, such that a given load is being consumed by the A system 108A.

Next following on from step S111, at step S112 the CPU 111 acquires the input voltage values measured by the input voltage meters 121A, 122A.

Next following on from step S112, at step S113 the CPU 111 switches the relays 103A, 104A OFF and stops the given load being consumed in the A system 108A.

Next following on from step S113, at step S114 the CPU 111 switches the relays 103A, 104A OFF and switches the relays 103B, 104B ON, such that a given load is being consumed by the B system 108B.

Next following on from step S114, at step S115 the CPU 111 acquires the input voltage values measured by the input voltage meters 121B, 122B.

Next following on from step S115, at step S116 the CPU 111 switches the relays 103B, 104B OFF and stops the given load being consumed in the B system 108B. Note that although in the flowchart illustrated in FIG. 6 the CPU 111 acquires input voltages in the sequence of the A system 108A then the B system 108B, the CPU 111 may acquire input voltages in the sequence of the B system 108B and then the A system 108A.

Next following on from step S116, at step S117 the CPU 111 computes a difference between the voltage in the A system 108A and voltage in the B system 108B. The following expression holds when a voltage value of the A system 108A is V_{A}, a voltage value of the B system 108B is V_{B}, a current value is I, a resistance value in the A system 108A is R_{A}, a resistance value in the B system 108B is R_{B}, and V_{A}, V_{B} are employed as the power supply voltage.

V_{A}=power supply voltage−I·R_{A}

V_{B}=power supply voltage−I·R_{B}

Thus the CPU 111 is able to surmise a magnitude relationship between R_{A} and R_{B} from a difference between V_{A} and V_{B}. Namely, when V_{A} is larger R_{A} is smaller, and when V_{B} is larger R_{B} is smaller.

Next following on from step S117, at step S118 the CPU 111 determines whether or not the voltage V_{A} of the A system 108A is larger than the voltage V_{B} of the B system 108B. In other words, the CPU 111 determines which of the systems has a smaller voltage drop.

In cases in which the result of determination at step S118 is that the voltage of the A system 108A is larger than the voltage of the B system 108B (step S118: Yes), then next at step S119 the CPU 111 decides to use the power distribution on the A system 108A side. Namely, the CPU 111 switches the relays 103A, 104A ON, and switches the relays 103B, 104B OFF.

However, in cases in which the result of determination at step S118 is that the voltage of the A system 108A is not larger than the voltage of the B system 108B (step S118: No), then next at step S120 the CPU 111 decides to use the power distribution on the B system 108B side. Namely, the CPU 111 switches the relays 103B, 104B ON and switches the relays 103A, 104A OFF.

By executing the above cycle of processing, the ECU 100 is able to select the power distribution pathway of low wiring resistance according to status. By selecting the power distribution pathway of low wiring resistance, the ECU 100 is able to suppress an increase in loss power of the moving body 1 in comparison to cases in which the power distribution pathway of low wiring resistance is not selected.

The above exemplary embodiment illustrates an example in which the moving body 1 has power distribution pathways configured from two independent systems, however the present disclosure is not limited so such an example. For example, in cases in which the power distribution pathway is formed in a ring shape, the ECU 100 may surmise a magnitude relationship of resistance values for each of plural segments, and then select the segment having the lowest resistance for use in power distribution.

Note that the control processing executed in each of the above exemplary embodiments by a CPU reading and executing software (a program) may be executed by various processors other than a CPU. Examples of such processors include programmable logic devices (PLD) that allow circuit configuration to be modified post-manufacture, such as a field-programmable gate array (FPGA), and dedicated electric circuits, these being processors including a circuit configuration custom-designed to execute specific processing, such as an application specific integrated circuit (ASIC). The control processing may be executed by any one of these various types of processors, or may be executed by a combination of two or more of the same type or different types of processors (such as plural FPGAs, or a combination of a CPU and an FPGA). The hardware structure of these various types of processors is more specifically an electric circuit combining circuit elements such as semiconductor elements.

Moreover, although in each of the above exemplary embodiments an embodiment was described in which a program for the control processing was pre-stored (installed) on ROM or storage, there is no limitation thereto. The program may be provided in a format recorded on a non-transitory recording medium such as a compact disk read only memory (CD-ROM), digital versatile disk read only memory (DVD-ROM), universal serial bus (USB) memory, or the like. Moreover, the program may be provided in a format downloadable from an external device over a network.

In consideration of the above circumstances, an object of the present disclosure is to provide a control device, moving body, control method, and control program that suppress an increase in loss power.

A first aspect of the disclosure is a control device including a memory, and a processor coupled to the memory, wherein the processor is configured to acquire a status of each of a plurality of power distribution pathways provided at a moving body, and select a power distribution pathway having low resistance from among the plurality of power distribution pathways based on the acquired status, and cause power to be distributed via the selected power distribution pathway.

The first aspect of the present disclosure enables an increase in loss power arising in a power distribution pathway to be suppressed from occurring by selecting the power distribution pathway having low wiring resistance according to status.

A second aspect of the disclosure is the control device of the first aspect, wherein the processor is configured to acquire information related to a temperature of surroundings of each of the plurality of power distribution pathways, and select a power distribution pathway having a lowest temperature from among the plurality of power distribution pathways, as the power distribution pathway having low resistance.

The second aspect of the present disclosure enables an increase in loss power arising in a power distribution pathway to be suppressed from occurring by selecting the power distribution pathway at low temperature as the power distribution pathway of low resistance.

A third aspect of the disclosure is the control device of the second aspect, wherein the processor is configured to acquire the information related to the temperature of the surroundings of each of the plurality of power distribution pathways indirectly.

The third aspect of the present disclosure enables an increase in loss power arising in a power distribution pathway to be suppressed from occurring by selecting the power distribution pathway at low temperature as the power distribution pathway of low resistance based on information related to temperature acquired indirectly.

A fourth aspect of the disclosure is the control device of the third aspect, wherein the processor is configured to acquire the information related to the temperature of the surroundings of each of the plurality of power distribution pathways indirectly, based on a position of the sun.

The fourth aspect of the present disclosure enables an increase in loss power arising in a power distribution pathway to be suppressed from occurring by selecting the power distribution pathway at low temperature as the power distribution pathway of low resistance based on information related to the temperature acquired based on the position of the sun.

A fifth aspect of the disclosure is the control device of the third aspect, wherein the processor is configured to acquire the information related to the temperature of the surroundings of each of the plurality of power distribution pathways indirectly, based on a position of the sun as found using a captured image.

The fifth aspect of the present disclosure enables an increase in loss power arising in a power distribution pathway to be suppressed from occurring by selecting the power distribution pathway at low temperature as the power distribution pathway of low resistance based on information related to the temperature acquired based on the position of the sun as obtained from an image.

A sixth aspect of the disclosure is the control device of the first aspect, wherein the processor is configured to acquire a voltage drop for each of the plurality of power distribution pathways, and select a power distribution pathway having a lowest voltage drop from among the plurality of power distribution pathways, as the power distribution pathway having low resistance.

The sixth aspect of the present disclosure enables an increase in loss power arising in a power distribution pathway to be suppressed from occurring by selecting the power distribution pathway having the lowest voltage drop as the power distribution pathway of low resistance.

A seventh aspect of the disclosure is the control device of the first aspect, wherein the processor is configured to perform control to select the power distribution pathway having low resistance from among the plurality of power distribution pathways, in a state in which the moving body is stopped.

The seventh aspect of the present disclosure enables an increase in loss power arising in a power distribution pathway to be suppressed from occurring while the moving body is moving by selecting the power distribution pathway as the power distribution pathway of low resistance in a state in which the moving body is stopped.

An eighth aspect of the disclosure is a moving body including a plurality of power distribution pathway, and the control device of the first aspect.

The eighth aspect of the present disclosure enables the moving body to move while suppressing an increase in loss power arising in the power distribution pathway.

A ninth aspect of the disclosure is a control method, including by a processor, acquiring a status of each of a plurality of power distribution pathways provided at a moving body, and selecting a power distribution pathway having low resistance from among the plurality of power distribution pathways based on the acquired status, and causing power to be distributed via the selected power distribution pathway.

The ninth aspect of the present disclosure enables an increase in loss power arising in a power distribution pathway to be suppressed from occurring by selecting the power distribution pathway of low wiring resistance according to status.

A tenth aspect of the disclosure is a non-transitory storage medium storing a program that is executable by a computer to perform processing, the processing including acquiring a status of each of a plurality of power distribution pathways provided at a moving body, and selecting a power distribution pathway having low resistance from among the plurality of power distribution pathways based on the acquired status, and causing power to be distributed via the selected power distribution pathway.

A tenth aspect of the present disclosure enables an increase in loss power arising in a power distribution pathway to be suppressed from occurring by selecting the power distribution pathway of low wiring resistance according to status.

The present disclosure enables provision of a control device, moving body, control method, and control program that suppress an increase in loss power by selecting a power distribution pathway of low wiring resistance according to status.

What is claimed is:

1. A control device comprising:
a memory; and
a processor coupled to the memory, wherein the processor is configured to:
acquire a status of each of a plurality of power distribution pathways provided at a moving body; and
select a power distribution pathway having low resistance from among the plurality of power distribution pathways based on the acquired status, and cause power to be distributed via the selected power distribution pathway.

2. The control device of claim 1, wherein the processor is configured to:
acquire information related to a temperature of surroundings of each of the plurality of power distribution pathways; and
select a power distribution pathway having a lowest temperature from among the plurality of power distribution pathways, as the power distribution pathway having low resistance.

3. The control device of claim 2, wherein the processor is configured to acquire the information related to the temperature of the surroundings of each of the plurality of power distribution pathways indirectly.

4. The control device of claim 3, wherein the processor is configured to acquire the information related to the temperature of the surroundings of each of the plurality of power distribution pathways indirectly, based on a position of the sun.

5. The control device of claim 3, wherein the processor is configured to acquire the information related to the temperature of the surroundings of each of the plurality of power distribution pathways indirectly, based on a position of the sun as found using a captured image.

6. The control device of claim 1, wherein the processor is configured to:
acquire a voltage drop for each of the plurality of power distribution pathways; and
select a power distribution pathway having a lowest voltage drop from among the plurality of power distribution pathways, as the power distribution pathway having low resistance.

7. The control device of claim 1, wherein the processor is configured to perform control to select the power distribution pathway having low resistance from among the plurality of power distribution pathways, in a state in which the moving body is stopped.

8. A moving body comprising:
a plurality of power distribution pathways; and
the control device of claim 1.

9. A control method, comprising:
by a processor:
acquiring a status of each of a plurality of power distribution pathways provided at a moving body; and
selecting a power distribution pathway having low resistance from among the plurality of power distribution pathways based on the acquired status, and causing power to be distributed via the selected power distribution pathway.

10. A non-transitory storage medium storing a program that is executable by a computer to perform processing, the processing comprising:
acquiring a status of each of a plurality of power distribution pathways provided at a moving body; and
selecting a power distribution pathway having low resistance from among the plurality of power distribution pathways based on the acquired status, and causing power to be distributed via the selected power distribution pathway.
